(19) United States
(12) Patent Application Publication
(10) Pub. No.: US 2025/0167326 A1
(43) Pub. Date: May 22, 2025

(54) BATTERY CELL, BATTERY PACK INCLUDING SAME AND METHOD OF PROTECTING BATTERY PACK

(71) Applicant: SAMSUNG SDI CO., LTD., Yongin-si (KR)

(72) Inventor: Tae Jin LEE, Suwon-si (KR)

(21) Appl. No.: 18/949,871

(22) Filed: Nov. 15, 2024

(30) Foreign Application Priority Data
Nov. 21, 2023 (KR) 10-2023-0161870

(51) Int. Cl. H01M 10/48; A62C 3/16; H01M 10/42; H01M 10/44; H01M 50/107; H01M 50/383; H02J 7/00

(52) U.S. Cl. CPC H01M 10/486; A62C 3/16; H01M 10/425; H01M 10/443; H01M 50/107; H01M 50/383; H01M 2010/4271; H01M 2200/10; H02J 7/00309

(57) ABSTRACT

A battery pack includes a plurality of battery cells, a first temperature label and a second temperature label attached to a battery cell of the battery cells at different positions of the battery cell, each of the first and second temperature labels being configured to measure a temperature of the battery cell at a corresponding position, and a controller configured to determine an abnormal state of the battery cell based on a temperature difference between a first temperature and a second temperature measured through the first temperature label and the second temperature label.

### CROSS-REFERENCE TO RELATED APPLICATION

The present application claims priority to and the benefit of Korean Patent Application No. 10-2023-0161870, filed on Nov. 21, 2023, in the Korean Intellectual Property Office, the entire disclosure of which is incorporated herein by reference.

### BACKGROUND

### 1. Field

Aspects of embodiments of the present disclosure relate to a battery cell, a battery pack including the same, and a method of protecting the battery pack.

### 2. Description of the Related Art

Unlike primary batteries, which cannot be recharged, secondary batteries are batteries that can generally be charged and discharged. Low-capacity batteries in which a single battery cell is packaged are used in small and portable electronic devices such as mobile phones and camcorders. Large-capacity battery modules, in which dozens of battery packs are connected, are used as power sources for driving motors in electric bicycles, electric scooters, hybrid automobiles, electric automobiles, and the like.

Among these secondary batteries, a cylindrical secondary battery includes a cylindrical electrode assembly, a cylindrical can for accommodating the electrode assembly and an electrolyte, and a cap assembly, which is coupled to an opening of the can to seal the can and allow a current generated in the electrode assembly to flow to an external device. The cylindrical secondary battery has a structure in which the can with a negative polarity and the cap assembly with a positive polarity are insulated from each other by a gasket.

A thermal runaway phenomenon may occur in the cylindrical secondary battery due to abnormal operating conditions such as an internal short circuit, overcharge, a high temperature environment, and deformation due to an external impact. This thermal runaway phenomenon occurs when a large amount of heat accumulates inside the battery and causes a chain reaction that may cause the battery to ignite and lead to an explosion.

The above information disclosed in this Background section is for enhancement of understanding of the background of the present disclosure, and therefore, it may contain information that does not constitute related (or prior) art.

### SUMMARY

Aspects of some embodiments of the present disclosure are directed to a battery cell allowing an abnormal state of the battery cell to be detected before thermal runaway occurs, a battery pack including the same, and a method of protecting the battery pack.

However, objects that the present disclosure intends to achieve are not limited to the above-described objects and other objects that are not described may be clearly understood by those skilled in the art from the following description.

According to some embodiments of the present disclosure, there is provided a battery pack including: a plurality of battery cells; a first temperature label and a second temperature label attached to a battery cell of the battery cells at different positions of the battery cell, each of the first and second temperature labels being configured to measure a temperature of the battery cell at a corresponding position; and a controller configured to determine an abnormal state of the battery cell based on a temperature difference between a first temperature and a second temperature measured through the first temperature label and the second temperature label.

In some embodiments, the battery cell is formed in a cylindrical shape.

In some embodiments, the battery cell includes: an electrode assembly including a first electrode plate and a second electrode plate; a cylindrical can configured to embed the electrode assembly; and a cap assembly configured to cover an open area of the cylindrical can, wherein the first temperature label is attached to an upper portion of a sidewall of the cylindrical can, and the second temperature label is attached to a bottom of the cylindrical can.

In some embodiments, the controller is configured to: determine the abnormal state of the battery cell in response to at least one of the first temperature and the second temperature is greater than or equal to a reference temperature; and not determine the abnormal state of the battery cell in response to at least one of the first temperature and the second temperature is less than the reference temperature.

In some embodiments, in response to at least one of the first temperature and the second temperature being greater than or equal to the reference temperature, the controller is configured to calculate a temperature difference between the first temperature and the second temperature, to compare the calculated temperature difference with a threshold value, and to determine the abnormal state of the battery cell based on a result of the comparison.

In some embodiments, the threshold value is set based on a distance between the first temperature label and the second temperature label.

In some embodiments, the controller is configured to determine the battery cell to be in the abnormal state in response to the temperature difference being greater than or equal to the threshold value.

In some embodiments, the controller is configured to turn off a switch on a charging and discharging path to stop charging and discharging in response to at least one battery cell among the plurality of battery cells being in the abnormal state.

In some embodiments, the controller is configured to operate a fire extinguisher of the battery cell to inject a fire extinguishing agent into the battery cell in response to a temporary decrease in temperature being detected due to a vent operation after the switch is turned off.

According to some embodiments of the present disclosure, there is provided a battery cell including: an electrode assembly including a first electrode plate and a second electrode plate; a cylindrical can configured to embed the electrode assembly; a cap assembly configured to cover an open area of the cylindrical; and a first temperature label and a second temperature label attached to the cylindrical can at different positions of the cylindrical can.

In some embodiments, the cylindrical can includes: a circular-shaped bottom; a sidewall extending upward from the circular-shaped bottom; and a banding portion configured to fix the cap assembly by bending the sidewall.

In some embodiments, the first temperature label and the second temperature label are attached to the cylindrical can at different positions with a height difference.

In some embodiments, the first temperature label is attached to an upper portion of the sidewall of the cylindrical can, and the second temperature label is attached to the circular-shaped bottom of the cylindrical can.

In some embodiments, the battery cell further includes: a vent between an upper portion of the electrode assembly and the cap assembly and configured to discharge a gas; and a fire extinguisher above the vent and configured to inject a fire extinguishing agent when a gas is discharged through the vent.

According to some embodiments of the present disclosure, there is provided a method of protecting a battery pack, the method including: detecting, by a processor, a first temperature and a second temperature measured through a first temperature label and a second temperature label attached to a battery cell; determining, by the processor, whether at least one of the first temperature and the second temperature is greater than or equal to a reference temperature; and in response to at least one of the first temperature and the second temperature being greater than or equal to the reference temperature, determining, by the processor, an abnormal state of the battery cell based on a temperature difference between the first temperature and the second temperature.

In some embodiments, in the determining of the abnormal state of the battery cell, the processor is configured to compare the temperature difference with a threshold value and to determine the abnormal state of the battery cell based on a result of the comparison.

In some embodiments, the threshold value is set based on a distance between the first temperature label and the second temperature label.

In some embodiments, in the determining of the abnormal state of the battery cell, the processor is configured to determine the battery cell to be in the abnormal state in response to the temperature difference being greater than or equal to the threshold value.

In some embodiments, in the determining of the abnormal state of the battery cell, the processor is configured to turns off a switch on a charging and discharging path to stop charging and discharging in response to the battery cell being determined to be in the abnormal state.

In some embodiments, in the determining of the abnormal state of the battery cell, the processor is configured to operate a fire extinguisher of the battery cell to inject a fire extinguishing agent into the battery cell in response to a temporary decrease in temperature being detected due to a vent operation after the switch is turned off.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a schematic diagram illustrating a battery cell according to some embodiments of the present disclosure;

FIG. 2 is a schematic diagram illustrating a cross section of the battery cell according to some embodiments of the present disclosure;

FIG. 3 is a diagram illustrating an example of attachment positions of a first temperature label and a second temperature label according to some embodiments of the present disclosure;

FIG. 4 is a schematic diagram illustrating a configuration of a battery pack according to some embodiments of the present disclosure;

FIG. 5 is a diagram illustrating a circuit of the battery pack according to some embodiments of the present disclosure;

FIG. 6 is a diagram illustrating an example of a battery module including a cylindrical battery cell according to some embodiments of the present disclosure;

FIG. 7 is a diagram illustrating a temperature variation over time at each temperature measurement point of the cylindrical battery cell according to some embodiments of the present disclosure; and

FIG. 8 is a flow diagram for describing a method of protecting a battery pack according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be interpreted as being singular or provided as a plurality.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

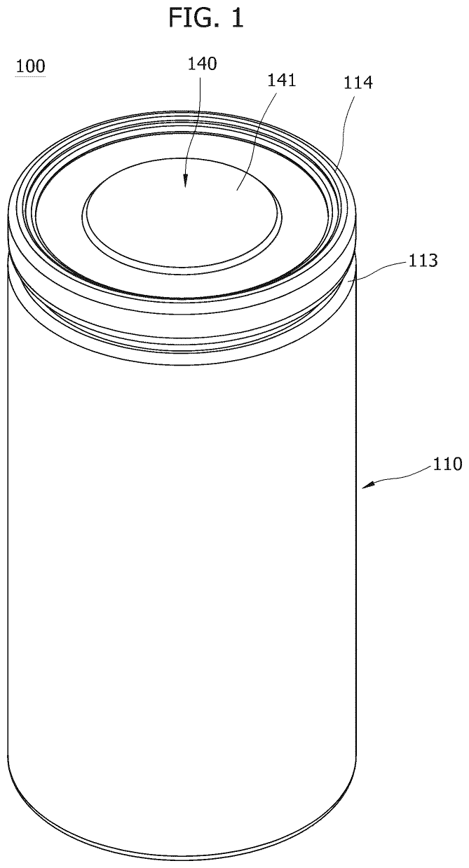

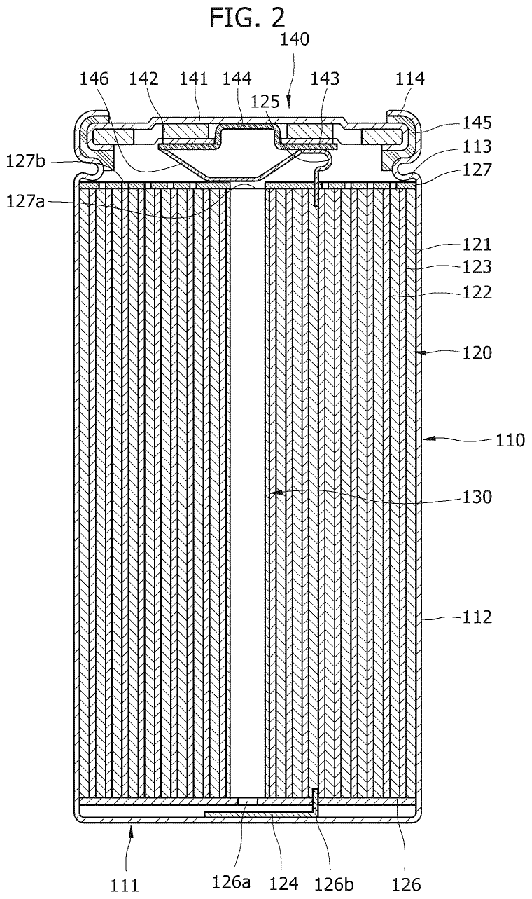

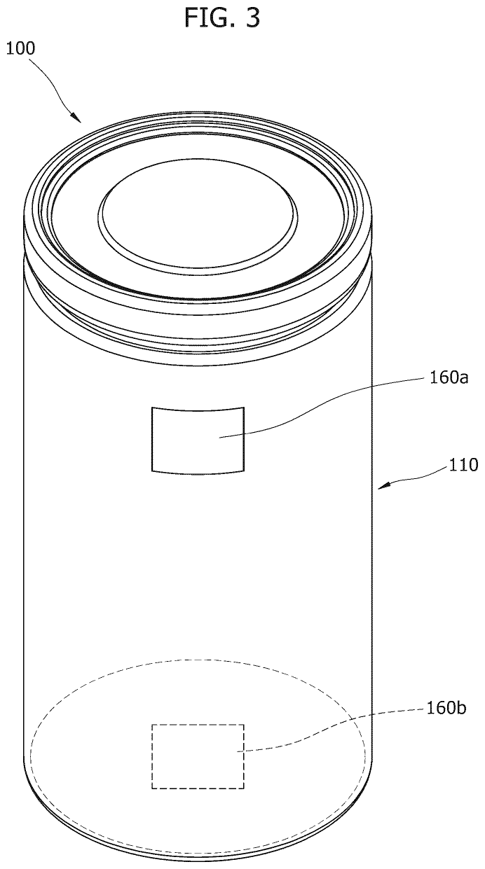

FIG. 1 is a schematic diagram illustrating a battery cell according to some embodiments of the present disclosure. FIG. 2 is a schematic diagram illustrating a cross section of the battery cell according to some embodiments of the present disclosure. FIG. 3 is a diagram illustrating an example of attachment positions of a first temperature label and a second temperature label according to some embodiments of the present disclosure.

Referring to FIGS. 1 and 2, a battery cell 100 according to some embodiments of the present disclosure may include a cylindrical can 110, an electrode assembly 120, and a cap assembly 140. In addition, in some cases, the battery cell 100 may further include a center pin 130. In addition, in the battery cell 100 according to some embodiments of the present disclosure, because the cap assembly 140 also performs a current interrupt operation, the cap assembly 140 may also be referred to as a current interrupt device.

The cylindrical can 110 may include a substantially circular bottom 111 and a cylindrical sidewall 112 extending a certain length upward from a circumference of the bottom 111. During a manufacturing process of the battery cell 100, the top of the cylindrical can 110 is open. Thus, during an assembly process of the battery cell 100, the electrode assembly 120 and the center pin 130 may be inserted into the cylindrical can 110 together with an electrolyte. The cylindrical can 110 may be made of, for example, steel, stainless steel, aluminum, an aluminum alloy, or an equivalent thereof, but the present disclosure is not limited thereto.

A first temperature label 160a and a second temperature label 160b may be attached to the cylindrical can 110 at different positions. In this case, the first temperature label 160a and the second temperature label 160b may be attached at different positions with a height difference. For example, as shown in FIG. 3, the first temperature label 160a may be attached to an upper sidewall 112 of the cylindrical can 110, and the second temperature label 160b may be attached to the bottom 111.

The first temperature label 160a and the second temperature label 160b may each measure a temperature of the attachment position (e.g., attachment point).

The first temperature label 160a and the second temperature label 160b may each be a temperature tape including an adhesive attachable to the cylindrical can 110. Here, the adhesive may be an adhesive material such as silicone which transmits a temperature (e.g., conducts heat or thermal energy).

Therefore, the first temperature label 160a may measure a first temperature of a corresponding position, and the second temperature label 160b may measure a second temperature of a corresponding position.

The first temperature and the second temperature measured through the first temperature label 160a and the second temperature label 160b may be used to determine an abnormal state of the battery cell 100.

As a capacity of battery cell 100 increases, a fire may occur, and when a fire occurs in the battery cell 100, the risk of chain ignition in other adjacent battery cells 100 increases. In order to prevent or substantially reduce this risk, it is desirable to detect an abnormal state of the battery cell 100 and take action in advance before thermal runaway (e.g., before thermal propagation) of the battery cell 100 occurs. Thus, in the embodiment of the present disclosure, the abnormal state of the battery cell 100 may be determined before thermal runaway (e.g., before thermal propagation) of the battery cell 100 occurs using the first temperature and the second temperature measured at the first temperature label 160a and the second temperature label 160b. A detailed description of a method of determining an abnormal state of the battery cell 100 using the first temperature and the second temperature will be described below.

In addition, the cylindrical can 110 may include a beading part 113 recessed inward below the cap assembly 140, and a crimping part 114 bent inward above the cap assembly 140 to prevent or substantially reduce the likelihood of the cap assembly 140 from being separated from the cylindrical can 110 toward the outside.

The electrode assembly 120 may be accommodated inside the cylindrical can 110. The electrode assembly 120 may include a first electrode plate and a second electrode plate. The first electrode plate may be one of a negative electrode plate and a positive electrode plate. The second electrode plate may be an electrode plate different from the first electrode plate. Here, it will be assumed that the first electrode plate is a positive electrode plate 122 and the second electrode plate is a negative electrode plate 121.

The electrode assembly 120 may include a negative electrode plate 121 in which a negative electrode collector plate is coated with a negative electrode active material (e.g., graphite, carbon, or the like), a positive electrode plate 122 in which a positive electrode collector plate is coated with a positive electrode active material (e.g., a transition metal oxide (such as LiCoO₂, LiNiO₂, LiMn₂O₄, or the like)), and a separator 123 positioned between the negative electrode plate 121 and the positive electrode plate 122 to prevent or substantially reduce likelihood of a short circuit between the negative and positive electrode plates 121 and 122 and to allow movement of lithium ions only. In addition, the negative electrode plate 121, positive electrode plate 122, and separator 123 may be wound in the form of substantially a cylindrical shape. Here, the negative electrode collector plate may be made of copper (Cu) foil, the positive electrode collector plate may be made of aluminum (Al) foil, and the separator may be made of polyethylene (PE) or polypropylene (PP), but the present disclosure is not limited thereto.

In addition, a negative electrode tab 124 protruding and extending downward a predetermined length may be welded to the negative electrode plate 121, and a positive electrode tab 125 protruding and extending a predetermined length may be welded to the positive electrode plate 122, and the reverse is also possible. The negative electrode tab 124 may be formed of, for example, Cu nickel (Ni), or the like, but the present disclosure is not limited thereto. The positive electrode tab 125 may be formed of, for example, Al or the like, but the present disclosure is not limited thereto.

In addition, the negative electrode tab 124 of the electrode assembly 120 may be welded to the bottom 111 of the cylindrical can 110. Therefore, the cylindrical can 110 may operate as a negative electrode. Conversely, in some examples, the positive electrode tab 125 may be welded to the bottom 111 of the cylindrical can 110, and the cylindrical can 110 may operate as a positive electrode.

In addition, a first insulating plate 126, which is coupled to the cylindrical can 110 and in which a first hole 126a is formed in the center and a second hole 126b is formed at an outer side of the first hole 126a, may be interposed between the electrode assembly 120 and the bottom 111. The first insulating plate 126 serves to prevent the electrode assembly 120 from being electrically in contact with the bottom 111 of the cylindrical can 110 or substantially reduce likelihood thereof. In particular, the first insulating plate 126 serves to prevent the positive electrode plate 122 of the electrode assembly 120 from being electrically in contact with the bottom 111 or substantially reduce likelihood thereof. Here, when a large amount of gas is generated due to an abnormality in the battery cell 100, the first hole 126a serves to allow the gas to quickly move upward through the center pin 130, and the second hole 126b serves to allow the negative electrode tab 124 to pass therethrough to be welded to the bottom 111.

In addition, a second insulating plate 127, which is coupled to the cylindrical can 110 and in which a first hole 127a is formed in the center and a second hole 127b is formed at an outer side of the first hole 127a, may be interposed between the electrode assembly 120 and the cap assembly 140. The second insulating plate 127 serves to prevent the electrode assembly 120 from being electrically in contact with the cap assembly 140 or substantially reduce likelihood thereof. In particular, the second insulating plate 127 serves to prevent the negative electrode plate 121 of the electrode assembly 120 from being electrically in contact with the cap assembly 140 or substantially reduce likelihood thereof. Here, when a large amount of gas is generated due to an abnormality of the battery cell 100, the first hole 127a serves to allow the gas to quickly move to the cap assembly 140, and the second hole 127b serves to allow the positive electrode tab 125 to pass therethrough to be welded to the cap assembly 140. In addition, during an electrolyte injection process, the second hole 127b serves to allow an electrolyte to quickly flow into the electrode assembly 120.

In addition, because diameters of the first holes 126a and 127a of the first and second insulating plates 126 and 127 are each formed to be smaller than a diameter of the center pin 130, the center pin 130 is prevented from being electrically in contact with the bottom 111 or the cap assembly 140 of the cylindrical can 110 due to an external impact or the likelihood of such contact is substantially reduced.

The center pin 130 is in the form of a hollow circular pipe and may be coupled to substantially the center of the electrode assembly 120. The center pin 130 may be made of, for example, steel, stainless steel, aluminum, an aluminum alloy, polybutylene terephthalate, and/or the like, but the present disclosure is not limited thereto. During charging and discharging of the battery, the center pin 130 serves to suppress deformation of the electrode assembly 120 and serves as a passage for a gas generated inside the battery cell 100. In some examples, the center pin 130 may be omitted.

The cap assembly 140 may include a top plate 141, a middle plate 142, an insulating plate 143, a bottom plate 144, and a vent 146.

The middle plate 142 is positioned below the top plate 141 and may have a substantially flat shape.

The insulating plate 143 may be formed in a circular ring shape with a predetermined width when viewed from the bottom. In addition, the insulating plate 143 serves to insulate the middle plate 142 from the bottom plate 144. The insulating plate 143 may be, for example, interposed between the middle plate 142 and the bottom plate 144 and ultrasonically welded, but the present disclosure is not limited thereto.

The vent 146 may interrupt a current and/or discharge a gas when a pressure inside the battery cell 100 increases. The vent 146 may discharge a gas as an internal pressure increases before thermal runaway. When a gas is generated inside the battery cell 100, a pressure increases due to the gas. In this case, when the pressure is greater than or equal to a preset reference pressure, the vent 146 may operate to discharge the gas. The reference pressure may be a minimum pressure set for the vent 146 to operate.

An exhaust gas generated inside the battery cell 100 in an abnormal operating condition, which is also known as thermal runaway or a thermal event of the battery cell 100, may be discharged to the outside of the battery cell 100 through the vent 146.

In addition, the cap assembly 140 may further include a fire extinguisher for injecting a liquid fire extinguishing agent and/or cooling water when a specific temperature and a gas are detected. For example, the fire extinguisher may be installed in an upper portion of the vent 146.

The fire extinguisher may block chain ignition by activating active extinguishing of an extinguishing agent present at a specific position. That is, when a fire occurs in the battery cell 100, there is a risk of chain ignition in other adjacent battery cells 100, and the fire extinguisher prevents or substantially reduces the likelihood of the chain ignition.

The battery cell 100 generates a large amount of heat during charging/discharging. The generated heat accumulates in the battery cell 100 and accelerates degradation of the battery cell 100. Thus, the battery cell 100 may include the fire extinguisher (e.g., a cooling member) to suppress degradation of the battery cell 100. The cooling member is provided below an accommodation space where the battery cell 100 is installed, but the present disclosure is not limited thereto, and the cooling member may be provided in an upper portion or a side surface according to the battery pack 10.

In the battery cell 100 configured as described above, the first temperature and the second temperature measured through the first temperature label 160a and the second temperature label 160b allow the abnormal state of the battery cell 100 to be determined, and thus advance measures may be taken before thermal runaway (e.g., before thermal propagation) of the battery cell 100 occurs.

In some embodiments of the present disclosure, the battery cell 100 and the cylindrical battery cell 100 are interchangeably described, but the battery cell 100 may be a cylindrical battery cell and thus have the same configuration.

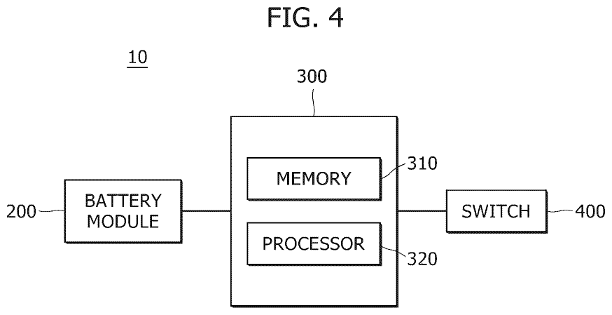

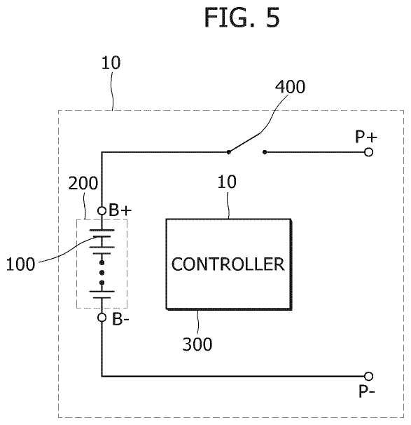

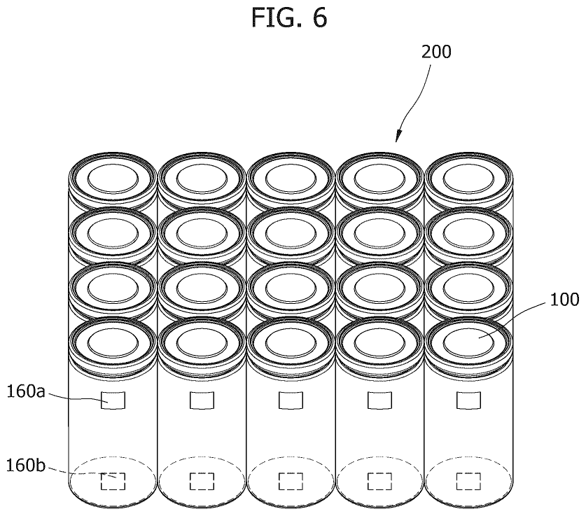

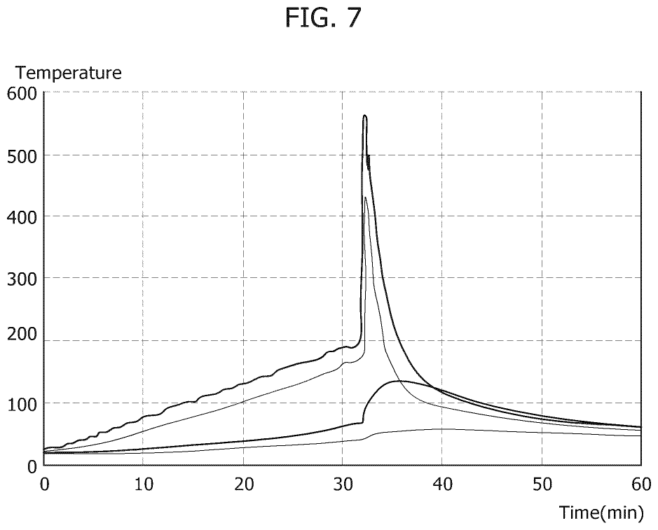

FIG. 4 is a schematic diagram illustrating a configuration of a battery pack according to some embodiments of the present disclosure. FIG. 5 is a diagram illustrating a circuit of the battery pack according to some embodiments of the present disclosure. FIG. 6 is a diagram illustrating an example of a battery module including a cylindrical battery cell according to some embodiments of the present disclosure. FIG. 7 is a diagram illustrating a temperature variation over time at each temperature measurement point of the cylindrical battery cell according to some embodiments of the present disclosure.

Referring to FIGS. 4 and 5, the battery pack 10 according to some embodiments of the present disclosure has a structure which may be electrically connected to an external device through a positive electrode connection terminal P(+) and a negative electrode connection terminal P(−). When the external device is a load, the battery pack 10 operates as a power source for supplying power to the load and is discharged. The external device serving as a load may be, for example, an electronic device, a vehicle, or an energy storage system (ESS), and the vehicle may be, for example, an electric automobile, a hybrid automobile, or a smart mobility vehicle.

The battery pack 10 may include one or more battery modules 200, a switch 400, and a controller 300. However, embodiments of the present disclosure are not limited thereto, and the battery pack 10 may further include other components.

The battery module 200 may include a plurality of battery cells 100 and a module housing. The battery module 200 may include a plurality of cells connected to each other in series, in parallel, or a combination thereof. The battery modules 200 may be connected to each other in series, in parallel, or a combination thereof.

The battery cells 100 may be accommodated inside the module housing in a stacked form. The battery cell 100 may be provided with a positive electrode lead and a negative electrode lead. The battery cell 100 may be the cylindrical battery cell 100 shown in FIGS. 1 to 3. The first temperature label 160a and the second temperature label 160b (T-tape), which measure temperatures of different positions, are attached to the cylindrical battery cell 100. For example, the first temperature label 160a may be attached to the upper sidewall of the cylindrical can 110, and the second temperature label 160b may be attached to a surface of the bottom 111 of the cylindrical battery cell 100. For a detailed description of the cylindrical battery cell 100, FIGS. 1 to 3 can be referred to.

When the first temperature label 160a and the second temperature label 160b are attached to the plurality of cylindrical battery cells 100, the battery module 200 may be as shown in FIG. 6. Referring to FIG. 6, the first temperature label 160a may be attached to the sidewall of each cylindrical battery cell 100, and the second temperature label 160b may be attached to the bottom 111 of each cylindrical battery cell 100.

The switch 400 may be controlled by the controller 300 to control an electrical connection between the battery module 200 and an external device.

The switch 400 may be connected between the battery module 200 and at least one of the pack terminals P+ and P− and block/allow the electrical connection between the battery module 200 and the external device. The switch 400 may be installed on a power line which is provided as a current path for charging and discharging the battery module 200.

When the switch 400 is turned on, power may be supplied from the battery module 200 to the external device or power may be supplied from the external device to the battery module 200.

The switch 400 may be include one or more known switching devices such as relays and transistors.

The controller 300 may determine an abnormal state of each battery cell 100 using first and second temperatures measured through the first temperature label 160a and the second temperature label 160b of each battery cell 100.

When an abnormal condition of the battery cell 100 is detected, the controller 300 may turn the switch 400 off to stop charging and discharging or detect a temperature decrease due to the operation of the vent 146 to operate the fire extinguisher.

The controller 300 may include a memory 310 and a processor 320. The controller 300 may be included in a battery management system (BMS).

The memory 310 may store a program (application) of the processor 320, which is used to determine the abnormal state of each battery cell 100. In some examples, the memory 310 may store commands used in the operation of the processor 320. In some examples, the memory 310 may be embedded in the processor 320 or connected to the processor 320 through a bus. In some examples, the memory 310 storing a table may be a nonvolatile memory.

The processor 320 may detect the first and second temperatures measured through the first temperature label 160a and the second temperature label 160b attached to the battery cell 100.

When the first temperature and the second temperature are detected, the processor 320 may determine an abnormal state of each battery cell 100 on the basis of the first temperature and the second temperature.

When a gas is generated inside the cylindrical battery cell 100 and thus the internal pressure increases, a temperature inside the cylindrical battery cell 100 increases. That is, looking at a state equation of an ideal gas that is PV=nRT (here, P denotes a pressure, V denotes a volume, n denotes the number of moles, R denotes a gas constant, and T denotes a temperature), it can be seen that the pressure and the temperature are proportional. By applying the proportional relationship between the pressure and the temperature, it can be seen that, when the pressure increases due to gas generation inside the cylindrical battery cell 100, the temperature increases.

In addition, a gas pressure is expressed as P=pgdh (here, P denotes a gas pressure, p denotes a fluid density, g denotes acceleration of gravity, and dh denotes a height difference). It can be seen that the pressure is proportional to the height difference.

Thus, it can be seen that the cylindrical battery cell 100 has a temperature difference between the upper and lower portions due to the height difference. That is, there may be a temperature difference between the first temperature measured at the first temperature label 160a attached to the upper sidewall of the cylindrical can 110 and the second temperature measured at the second temperature label 160b attached to the bottom 111 of the cylindrical can 110.

Thus, the processor 320 may detect the abnormal state of the cylindrical battery cell 100 using the relationship between the pressure and the height difference inside the cylindrical battery cell 100. That is, when a gas is generated before thermal runaway (e.g., before thermal propagation) of the cylindrical battery cell 100 occurs, the processor 320 may detect the abnormal state of the cylindrical battery cell 100 using the temperature difference between the upper and lower portions of the cylindrical battery cell 100.

In addition, a temperature variation over time for each temperature measurement point (e.g., measurement position) of the cylindrical battery cell 100 may be as shown in FIG. 7. Referring to FIG. 7, it can be seen that thermal runaway (e.g., explosion) occurs at a temperature of 180° C. or more.

To protect the battery pack 10, the abnormal state of the battery cell 100 should be detected before thermal runaway occurs. However, it is inefficient to always determine the abnormal state of the battery cell 100 before thermal runaway occurs.

Therefore, it is desirable to utilize a criterion for determining the abnormal state of the battery cell 100 to prevent thermal runaway of the battery cell 100 from occurring.

Thus, in some embodiments of the present disclosure, a reference temperature is set, and an abnormal state determination operation of the battery cell 100 is performed when a measured temperature is greater than or equal to the reference temperature. Here, the reference temperature is less than a temperature at which thermal runaway of the battery cell 100 occurs and may be arbitrarily set.

For example, the reference temperature may be a separator shutdown occurrence start temperature. The separator shutdown occurrence start temperature may be, for example, about 125° C.

Therefore, when the temperature of the battery cell 100 is less than the reference temperature (e.g., about 125° C.), the processor 320 does not perform an operation of determining the abnormal state of the battery cell 100. That is, when at least one of the first temperature and the second temperature is less than the reference temperature, the processor 320 does not perform the operation of determining the abnormal state of the battery cell 100.

When the temperature of the battery cell 100 is greater than or equal to the reference temperature, the processor 320 may perform the operation of determining the abnormal state of the battery cell 100. That is, when at least one of the first temperature and the second temperature is greater than or equal to the reference temperature, the processor 320 may perform the operation of determining the abnormal state of the battery cell 100.

When at least one of the first temperature and the second temperature is greater than or equal to the reference temperature, the processor 320 may calculate a temperature difference between the first temperature and the second temperature and determine the abnormal state of the battery cell 100 on the basis of the calculated temperature difference.

For example, the processor 320 may compare the temperature difference with a threshold value (e.g., a preset threshold value) and determine the abnormal state of battery cell 100 on the basis of the comparison result. Here, the threshold value may be a temperature value that is set according to a distance between the first temperature label 160a and the second temperature label 160b.

The first temperature label 160a and the second temperature label 160b may be attached at different positions with a height difference, and the measured temperature may vary according to the attachment position of the temperature label. Thus, the temperature difference between the first temperature and the second temperature may vary according to the distance between the first temperature label 160a and the second temperature label 160b.

For example, as the distance between the first temperature label 160a and the second temperature label 160b is shorter, the temperature difference may be smaller, and as the distance between the first temperature label 160a and the second temperature label 160b is longer, the temperature difference may be larger.

Thus, the threshold value for determining the abnormal state of battery cell 100 may be set differently according to the distance between the first temperature label 160a and the second temperature label 160b.

When the temperature difference is greater than or equal to the threshold value, the processor 320 may determine that the battery cell 100 is in an abnormal state. When the temperature difference is less than the threshold value, the processor 320 may determine that the battery cell 100 is in a normal state.

When at least one battery cell 100 among the battery cells 100 is determined to be in an abnormal state, the processor 320 may turn the switch 400 off on the charging and discharging path to stop charging and discharging. That is, when at least one battery cell 100 is determined to be in an abnormal state, the processor 320 may determine that this is a symptom of thermal runaway (e.g., a symptom of thermal propagation), stop charging and discharging operations, and concurrently (e.g., simultaneously) turn the switch 400 off to disable use of the battery module 200.

Even when the switch 400 is turned off, a gas may be generated inside the battery cell 100, and thus the pressure may increase. When the pressure inside the battery cell 100 increases, the vent 146 operates.

When the vent 146 operates, a the temperature may temporary decrease.

When the temperature temporarily decreases due to the operation of the vent 146, the processor 320 may determine that this is a symptom of thermal runaway and operate the fire extinguisher. The fire extinguisher may block chain ignition by activating active extinguishing of an extinguishing agent inside the battery cell 100.

Here, the processor 320 may be implemented as a central processing unit (CPU) or a system on chip (SoC), may run an operating system or an application to control a plurality of hardware or software components connected to the processor 320, and may perform various types of data processing and various arithmetic operations. The processor 320 may execute at least one command stored in the memory 310 and store the execution result data in the memory 310.

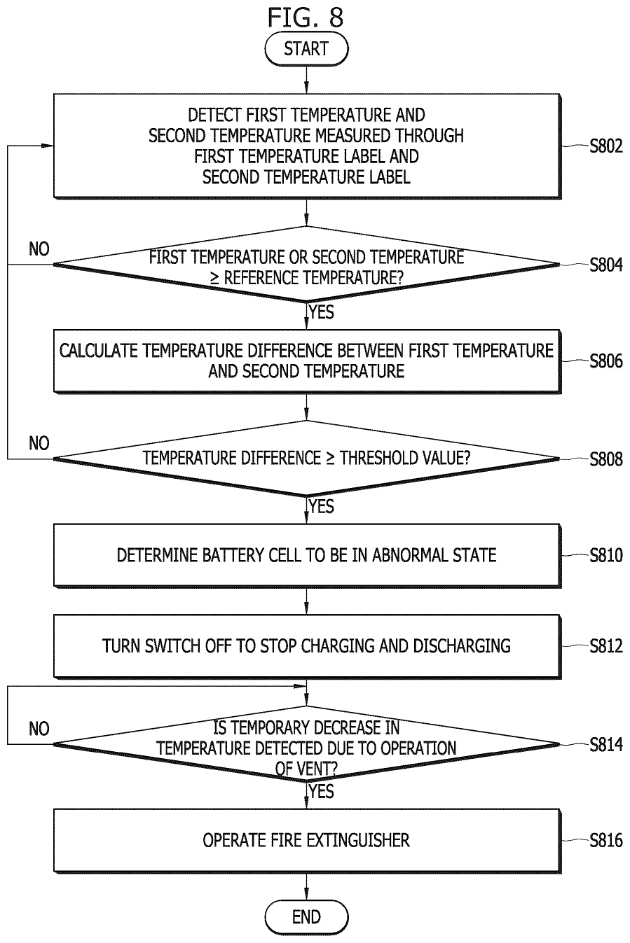

FIG. 8 is a flow diagram for describing a method of protecting a battery pack according to some embodiments of the present disclosure.

Referring to FIG. 8, the processor 320 detects the first and second temperatures measured through the first temperature label 160a and the second temperature label 160b attached to the battery cell 100 (S802).

The processor 320 determines whether at least one of the first temperature and the second temperature is greater than or equal to the reference temperature (S804).

When at least one of the first temperature and the second temperature is greater than or equal to the reference temperature, the processor 320 calculates a temperature difference between the first temperature and the second temperature (S806) and determines whether the temperature difference is greater than or equal to a threshold value (e.g., a preset threshold value) (S808). Here, the threshold value may be a value which is set differently according to a distance between the first temperature label 160a and the second temperature label 160b. Thus, the processor 320 may acquire a threshold value corresponding to the distance between the first temperature label 160a and the second temperature label 160b from the memory 310. Then, the processor 320 may compare the temperature difference with the acquired threshold value.

When it is determined as a result of operation S808 that the temperature difference is greater than or equal to the threshold value, the processor 320 determines the battery cell 100 to be in an abnormal state (S810) and turns the switch 400 off on the charging and discharging path to stop charging and discharging of the battery cell 100 (S812). That is, when at least one battery cell 100 is determined to be in an abnormal state, the processor 320 may determine that this is a symptom of thermal runaway (e.g., before thermal propagation), stop charging and discharging operations, and concurrently (e.g., simultaneously) turn the switch 400 off to disable use of the battery module 200.

Then, when a temporary decrease in temperature is detected due to the operation of the vent 146 (S814), the processor 320 determines that this is a symptom of thermal runaway and operates the fire extinguisher (S816). Even when the switch 400 is turned off, a gas is generated inside the battery cell 100, and thus the pressure increases. When the pressure inside the battery cell 100 increases, the vent 146 operates. When the vent 146 operates, the temperature may temporarily decrease. When the phenomenon in which the temperature temporarily decreases occurs due to the operation of the vent 146, the processor 320 may determine that this is a symptom of thermal runaway and operate the fire extinguisher. The fire extinguisher may block chain ignition by activating active extinguishing of an extinguishing agent inside the battery cell 100.

As described above, according to the present disclosure, the abnormal state of the battery cell is determined on the basis of the first temperature and the second temperature measured through the first temperature label and the second temperature label attached to the battery cell at different positions. Thus, the abnormal state of the battery cell may be detected before thermal runaway (e.g., before thermal propagation) of the battery cell occurs.

According to the present disclosure, when the abnormal state of the battery cell is detected, the switch on the charging and discharging path is turned off to prevent the battery module from being used (e.g., to prevent current draw from the battery module) so that thermal runaway of the battery cell may be prevented in advance (e.g., be preemptively prevented).

According to the present disclosure, when the abnormal state of the battery cell is detected, active fire extinguishing, such as with a fire extinguishing agent, is activated inside the battery cell so that chain ignition of the battery cell may be prevented or the likelihood thereof may be substantially reduced.

In accordance with the present disclosure, an abnormal state of a battery cell is determined on the basis of a first temperature and a second temperature measured at a first temperature label and a second temperature label attached to the battery cell at different positions. Thus, the abnormal state of the battery cell can be detected before thermal runaway (e.g., before thermal propagation) of the battery cell occurs.

In accordance with the present disclosure, when the abnormal state of the battery cell is detected, a switch on a charging and discharging path is turned off to prevent a battery module from being used so that thermal runaway of the battery cell can be prevented in advance.

In accordance with the present disclosure, when the abnormal state of the battery cell is detected, active fire extinguishing, such as with a fire extinguishing agent, is activated inside the battery cell so that chain ignition of the battery cell can be prevented or the likelihood thereof may be substantially reduced.

However, effects that can be achieved through the present disclosure are not limited to the above-described effects and other effects that are not described may be clearly understood by those skilled in the art from the detailed descriptions.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A battery pack comprising:
a plurality of battery cells;
a first temperature label and a second temperature label attached to a battery cell of the battery cells at different positions of the battery cell, each of the first and second temperature labels being configured to measure a temperature of the battery cell at a corresponding position; and
a controller configured to determine an abnormal state of the battery cell based on a temperature difference between a first temperature and a second temperature measured through the first temperature label and the second temperature label.

2. The battery pack of claim 1, wherein the battery cell is formed in a cylindrical shape.

3. The battery pack of claim 2, wherein the battery cell comprises:
an electrode assembly comprising a first electrode plate and a second electrode plate;
a cylindrical can configured to embed the electrode assembly; and
a cap assembly configured to cover an open area of the cylindrical can,
wherein the first temperature label is attached to an upper portion of a sidewall of the cylindrical can, and the second temperature label is attached to a bottom of the cylindrical can.

4. The battery pack of claim 1, wherein the controller is configured to:
determine the abnormal state of the battery cell in response to at least one of the first temperature and the second temperature is greater than or equal to a reference temperature; and
not determine the abnormal state of the battery cell in response to at least one of the first temperature and the second temperature is less than the reference temperature.

5. The battery pack of claim 4, wherein, in response to at least one of the first temperature and the second temperature being greater than or equal to the reference temperature, the controller is configured to calculate a temperature difference between the first temperature and the second temperature, to compare the calculated temperature difference with a threshold value, and to determine the abnormal state of the battery cell based on a result of the comparison.

6. The battery pack of claim 5, wherein the threshold value is set based on a distance between the first temperature label and the second temperature label.

7. The battery pack of claim 5, wherein, the controller is configured to determine the battery cell to be in the abnormal state in response to the temperature difference being greater than or equal to the threshold value.

8. The battery pack of claim 1, wherein, the controller is configured to turn off a switch on a charging and discharging path to stop charging and discharging in response to at least one battery cell among the plurality of battery cells being in the abnormal state.

9. The battery pack of claim 8, wherein, the controller is configured to operate a fire extinguisher of the battery cell to inject a fire extinguishing agent into the battery cell in response to a temporary decrease in temperature being detected due to a vent operation after the switch is turned off.

10. A battery cell comprising:
an electrode assembly comprising a first electrode plate and a second electrode plate;
a cylindrical can configured to embed the electrode assembly;
a cap assembly configured to cover an open area of the cylindrical; and
a first temperature label and a second temperature label attached to the cylindrical can at different positions of the cylindrical can.

11. The battery cell of claim 10, wherein the cylindrical can comprises:
a circular-shaped bottom;
a sidewall extending upward from the circular-shaped bottom; and
a banding portion configured to fix the cap assembly by bending the sidewall.

12. The battery cell of claim 11, wherein the first temperature label and the second temperature label are attached to the cylindrical can at different positions with a height difference.

13. The battery cell of claim 12, wherein:
the first temperature label is attached to an upper portion of the sidewall of the cylindrical can; and
the second temperature label is attached to the circular-shaped bottom of the cylindrical can.

14. The battery cell of claim 10, further comprising:
a vent between an upper portion of the electrode assembly and the cap assembly and configured to discharge a gas; and
a fire extinguisher above the vent and configured to inject a fire extinguishing agent when a gas is discharged through the vent.

15. A method of protecting a battery pack, the method comprising:
detecting, by a processor, a first temperature and a second temperature measured through a first temperature label and a second temperature label attached to a battery cell;
determining, by the processor, whether at least one of the first temperature and the second temperature is greater than or equal to a reference temperature; and
in response to at least one of the first temperature and the second temperature being greater than or equal to the reference temperature, determining, by the processor, an abnormal state of the battery cell based on a temperature difference between the first temperature and the second temperature.

16. The method of claim 15, wherein, in the determining of the abnormal state of the battery cell, the processor is configured to compare the temperature difference with a threshold value and to determine the abnormal state of the battery cell based on a result of the comparison.

17. The method of claim 16, wherein the threshold value is set based on a distance between the first temperature label and the second temperature label.

18. The method of claim 16, wherein, in the determining of the abnormal state of the battery cell, the processor is configured to determine the battery cell to be in the abnormal state in response to the temperature difference being greater than or equal to the threshold value.

19. The method of claim 18, wherein, in the determining of the abnormal state of the battery cell, the processor is configured to turns off a switch on a charging and discharging path to stop charging and discharging in response to the battery cell being determined to be in the abnormal state.

20. The method of claim 19, wherein, in the determining of the abnormal state of the battery cell, the processor is configured to operate a fire extinguisher of the battery cell to inject a fire extinguishing agent into the battery cell in response to a temporary decrease in temperature being detected due to a vent operation after the switch is turned off.
